(19) United States
(12) Patent Application Publication
(10) Pub. No.: US 2025/0340179 A1
(43) Pub. Date: Nov. 6, 2025

(54) AERODYNAMIC ARTICULATED FLOATING STEERABLE WHEEL HOUSING

(71) Applicant: APTERA MOTORS CORP., Carlsbad, CA (US)

(72) Inventors: Chris ANTHONY, CARLSBAD, CA (US); Steve FAMBRO, Carlsbad, CA (US); Jason C. HILL, Costa Mesa, CA (US); Marco TOSO, TURIN (IT)

(73) Assignee: APTERA MOTORS CORP., Carlsbad, CA (US)

(21) Appl. No.: 18/655,295

(22) Filed: May 5, 2024

(51) Int. Cl. B60R 19/48; B60Q 1/26; B60R 19/00; B62D 35/00; B62D 65/16

(52) U.S. Cl. CPC B60R 19/48; B60Q 1/2661; B62D 35/00; B62D 65/16; B60R 2019/002

(57) ABSTRACT

The present invention provides an aerodynamic housing for the steerable wheels of a vehicle. The housings may present a minimal profile perpendicular to the axis of motion and substantially match the streamlines of the airflow around the body of the vehicle to minimize drag. The housings may steer with the wheels and may float with the wheel suspensions. The housings may include front and rear bumpers to minimize damage to the housings. The housings may further be articulated; that is to say that a portion of the housings may be rotated or otherwise moved clear of the wheels, to enable maintenance, repair, and/or servicing without being disassembled. The housings may include appropriate mechanisms for securing the articulated portion of the housings during vehicle operation.

### TECHNICAL FIELD

The present invention relates to aerodynamic housings for the steerable wheels of a vehicle. The housings steer with the wheels and float with the wheel suspensions. The housings are further articulated, that is, a portion of the housings may be rotated or otherwise moved clear of the wheels, to enable maintenance, repair and/or servicing without being disassembled.

### BACKGROUND

Reducing drag is key to the design of vehicles having increased energy efficiency, which may provide cost-effective and environmentally friendly transportation. Aerodynamic drag is the cause of reduced energy efficiency, especially at high vehicle velocities, as the aerodynamic drag increases by the square of the velocity. By shaping the body of the vehicle in an aerodynamically efficient way, aerodynamic drag can be decreased, which can increase the energy efficiency. However, the body of the vehicle typically comprises several openings which contribute greatly to the drag. For example, each wheel may be arranged in a wheel housing. On the front axles of most passenger cars this takes the form of a relatively large cut-out in the shape of an arch with a relatively large gap between the wheel and wheel arch. This provides the required clearance for the steering of the wheels and vertical motion of the wheels during shock absorption. Such a large gap adversely affects the aerodynamics of the vehicle, and reduces its efficiency.

In order to further improve aerodynamics, the lateral opening of the wheelhouse may be covered with a wheel cover. However, wheel covers are typically used only for non-steerable wheels. In the case of steerable wheels, a large distance between the wheels and the wheel cover is required in order to avoid impeding the steering of the wheels. This required distance can be implemented via a smaller wheelbase, which has a negative effect on vehicle handling, or a correspondingly outwardly curved wheel cover which interferes with aerodynamics and is not preferred for design reasons. Wheel coverings that deform when the wheel is steered have been proposed to mitigate this effect. This solution brings other challenges, such as which elastic materials may be used to achieve the required displacement while at the same time providing a durable and aesthetic body panel.

In another approach the wheels are enclosed in rigid wheel housings that steer, at least partially, with the wheels. When the wheels are straight, the housing is substantially flush with the fender. When the wheels are steered the housing protrudes from the fender surface as necessary to retain clearance for the wheel. The actuation may be achieved actively, as by pistons, or passively, as by the action of the wheel itself.

Another challenge regards the suspension system. The suspension of the wheel may be independent of the housing, or it may move in concert with the housing. In the former case, the wheel housing provides the vertical clearance necessary for the spring action of the wheel. In the latter case, the fender must provide clearance for the spring action of the housing. The resulting gap increases the aerodynamic drag of the housing/fender assembly and may be less aesthetic than the former solution.

Overall, housing the wheel removes a primary advantage of the arched wheel opening of a standard vehicle, which is access to the wheel and tire for maintenance, repair and/or servicing. The importance of this feature cannot be overstated as consumer adoption may be predicated on the ability of the vehicle operator to perform the basic functions of filling the tire with air and changing a flat. Therefore, a wheel housing that may be removed by the user is highly desirable. Furthermore, the ease of such disassembly (and reassembly) is also important as a tool-based process (e.g. requiring a screwdriver or wrench) may be difficult to implement, especially under adverse conditions, such as on a slope, in wind, rain or snow, or simply in very cold or very hot conditions.

Some vehicles, such as roadsters, trikes, and aerodynamically shaped vehicles, have external wheels that are not housed in the main body but rather extended to the sides by the suspension elements. This arrangement of the wheels also adversely affects the aerodynamics of the vehicle. Therefore, a wheel housing, especially one which directs the airflow in alignment with that of the vehicle body, may be effective in significantly reducing the wheel drag. Here similar choices must be made, as for example, between a larger, static housing with internal clearance for the wheel steering and one with a slimmer, more aerodynamic profile that steers with the wheel. Likewise, the housing may be vertically stationary or move with the suspension. Since proximity to the fender is not an issue, the latter choice is less consequential, for example, not requiring a gap with the fender.

The disadvantage of external wheel housings is the same as that of internal wheel covers or housings: lack of driver access to the wheel and tire. While disassembly is an option, it would be preferrable not to have to take apart the car in order to change a flat. Thus, there is a long felt need for an aerodynamic wheel housing that may facilitate wheel access for the vehicle operator without disassembly.

A “steerable wheel” within the meaning of the present invention is a wheel of a vehicle by means of which a change in direction of travel of the vehicle can be affected by a wheel steering movement which is applied to the wheel by means of a steering system. The steering movement may have been generated manually, i.e. by driver input, and/or automatically, i.e. by an advanced driver assistance system (ADAS).

### SUMMARY

It is an object of the present invention to provide a housing for an external wheel of a vehicle that reduces aerodynamic drag.

It is an object of the present invention to provide a housing for an external wheel of a vehicle that steers with the wheel.

It is an object of the present invention to provide a housing for an external wheel of a vehicle that floats with the wheel suspension.

It is an object of the present invention to provide an articulated housing for an external wheel of a vehicle that may be actuated to allow access to the wheel and tire without disassembly.

These and other desirable features and characteristics will become apparent from the subsequent detailed description, the drawings, and the appended claims, when considered in view of this Summary.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1 illustrates a perspective view of aerodynamic wheel housings assembled to the external wheels of an aerodynamic vehicle, according to an embodiment of the present invention;

FIG. 2 illustrates a top view of an aerodynamic vehicle with wheel housings assembled to the external wheels with the airflow around the body and wheel housings, according to an embodiment of the present invention;

FIG. 3A illustrates a front, top, right perspective view of an aerodynamic wheel housing for an external wheel of a vehicle, according to an embodiment of the present invention;

FIG. 3B illustrates a back, bottom, left perspective view of an aerodynamic wheel housing for an external wheel of a vehicle, according to an embodiment of the present invention;

FIG. 4A illustrates a front view of an aerodynamic wheel housing for an external wheel of a vehicle, according to an embodiment of the present invention;

FIG. 4B illustrates a top view of an aerodynamic wheel housing for an external wheel of a vehicle, according to an embodiment of the present invention;

FIG. 4C illustrates a right view of an aerodynamic wheel housing for an external wheel of a vehicle, according to an embodiment of the present invention;

FIG. 5 illustrates an exploded view of an aerodynamic wheel housing assembly for an external wheel of a vehicle, according to an embodiment of the present invention;

FIG. 6 illustrates a back, top, right perspective view of an articulated wheel housing for an external wheel of a vehicle, according to an embodiment of the present invention;

FIG. 7 illustrates a detail view according to zone A of FIG. 6 of a latch for an articulated wheel housing for an external wheel of a vehicle, according to an embodiment of the present invention; and

FIG. 8 illustrates a perspective view of a wheel bracket and an adapter for a wheel housing for an external wheel of a vehicle, according to an embodiment of the present invention.

### DETAILED DESCRIPTION

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention. For a better understanding of the present invention, reference will be made to the following Description of the Embodiments, which is to be read in association with the accompanying drawings, which are incorporated in and constitute a part of this specification, show certain aspects of the subject matter disclosed herein and, together with the description, help explain some of the principles associated with the disclosed implementations.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

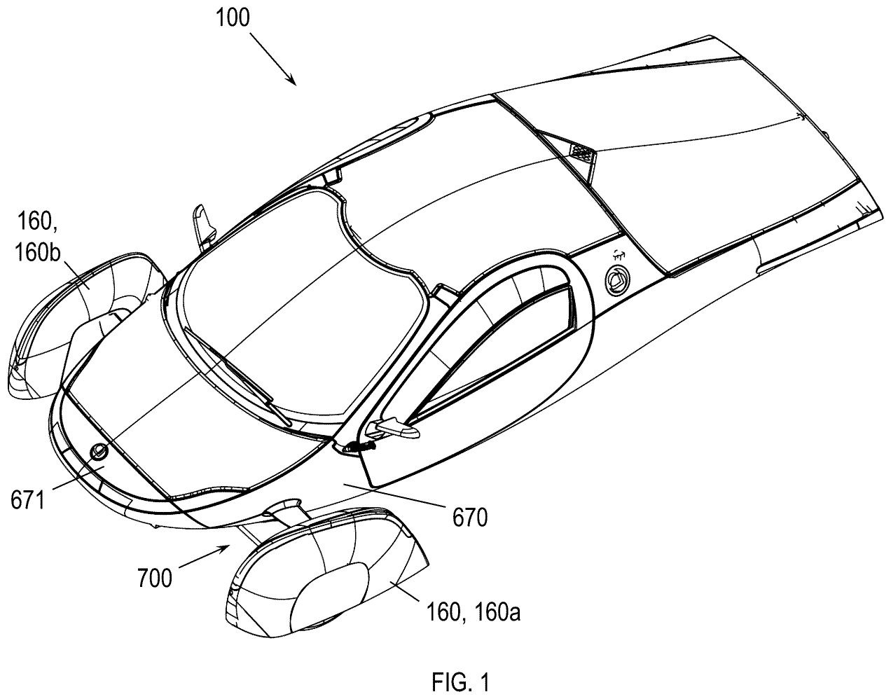

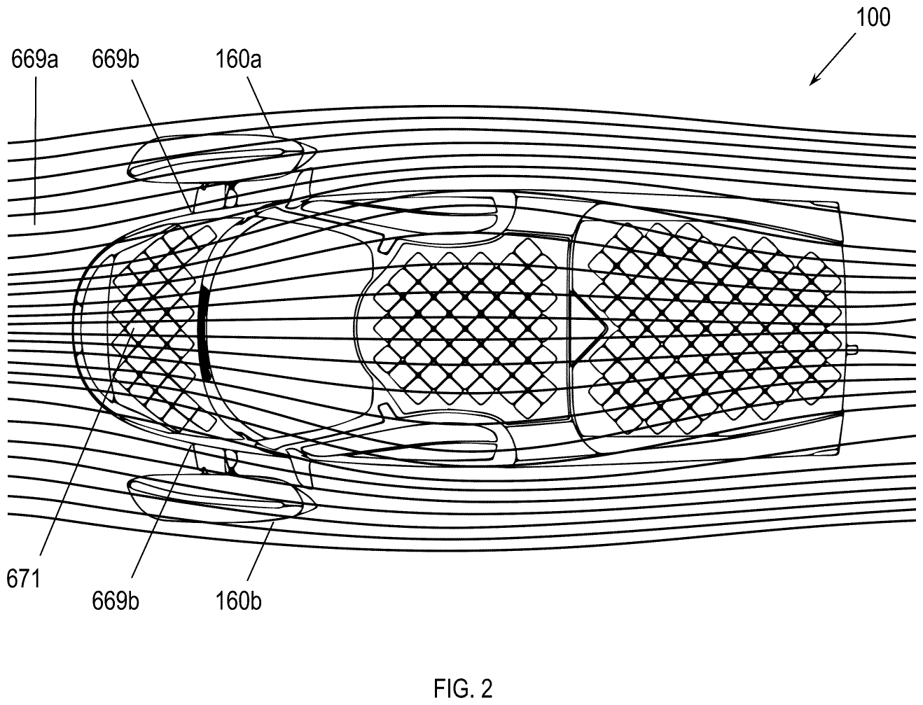

FIG. 1 illustrates aerodynamic wheel housings 160 (including left 160a and right 160b housings) disposed over the external wheels of an aerodynamic vehicle 100. The wheels are coupled to the vehicle 100 by the suspension and steering systems 700 leaving a gap between the wheels and the body 670 of the vehicle. From a top perspective, shown in FIG. 2, the airflow 669a separates into two laminar streams 669b at the nose 671 of the vehicle which then flow along the contours of the vehicle passing between the wheel and the body. The shape of the left 160a and right 160b wheel housings substantially matches the lines of flow of these streams thereby minimizing drag.

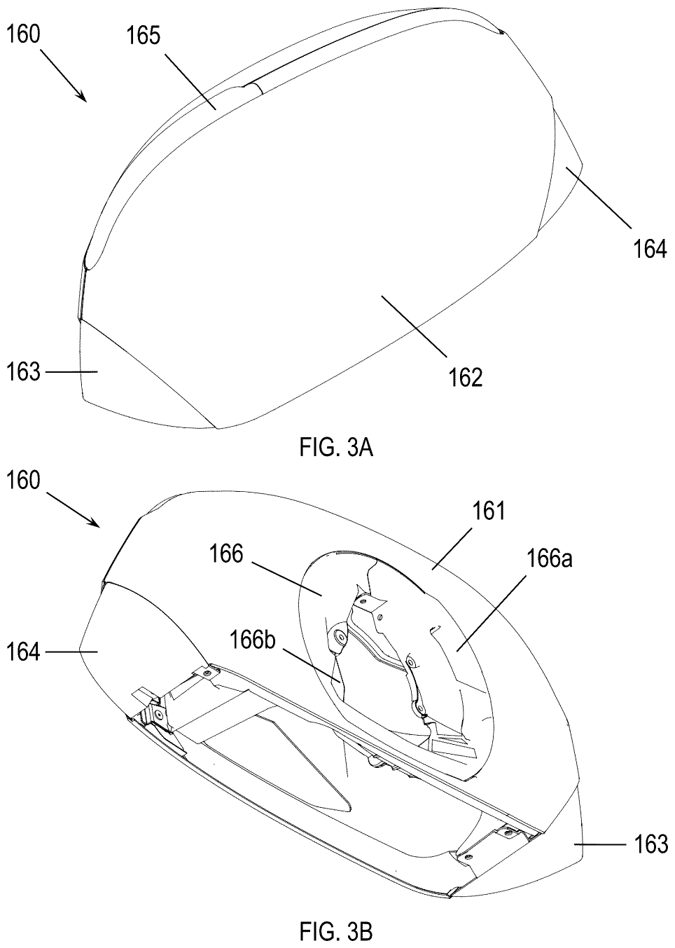

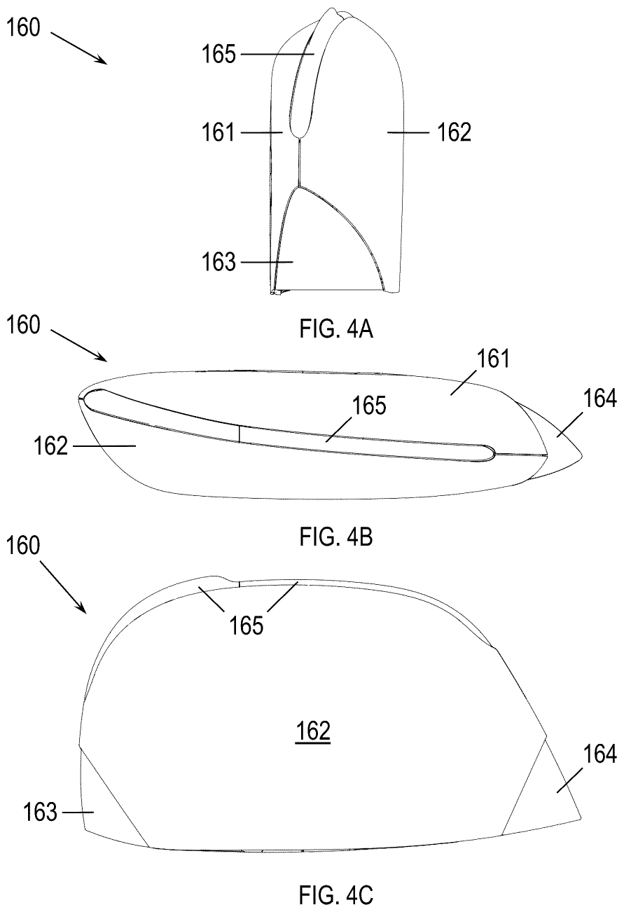

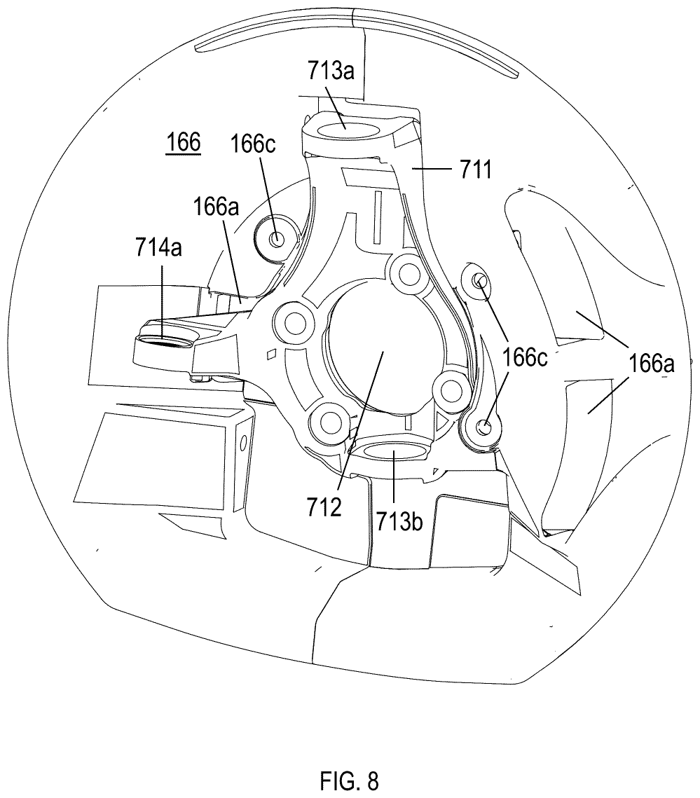

FIGS. 3A through 8 show the elements of the wheel housing. Referring to FIGS. 3A and 3B, the wheel housing 160 comprises an inner half 161, an outer half 162, front 163 and rear 164 bumpers and a light bar 165 disposed between the inner 161 and outer 162 halves. The inner 161 and outer 162 halves and light bar 165 may be composed of rigid material whereas the bumpers 163, 164 may be composed of shock absorbent material. An inner housing adapter 166 couples the housing to the steering and suspension systems (not shown). The inner housing adapter 166 includes air intake 166a and exhaust 166b for directing ambient air toward the in-wheel motor for the purpose of cooling. Referring to FIGS. 4A-4C, the aerodynamic design of the wheel housing 160 can be viewed from various angles. From the front view of FIG. 4A, the housing 160 presents a minimized profile which determines its drag cross section. From the top view of FIG. 4B, the shape of the wheel housing can be seen to mimic the streamlines of the airflow (as seen in FIG. 2), with a tapered leading edge angled toward the vehicle body and a trailing edge angled away from the vehicle body. From the side view of FIG. 4C, the exaggerated airfoil shape is visible with a near vertical leading edge and sloped trailing edge.

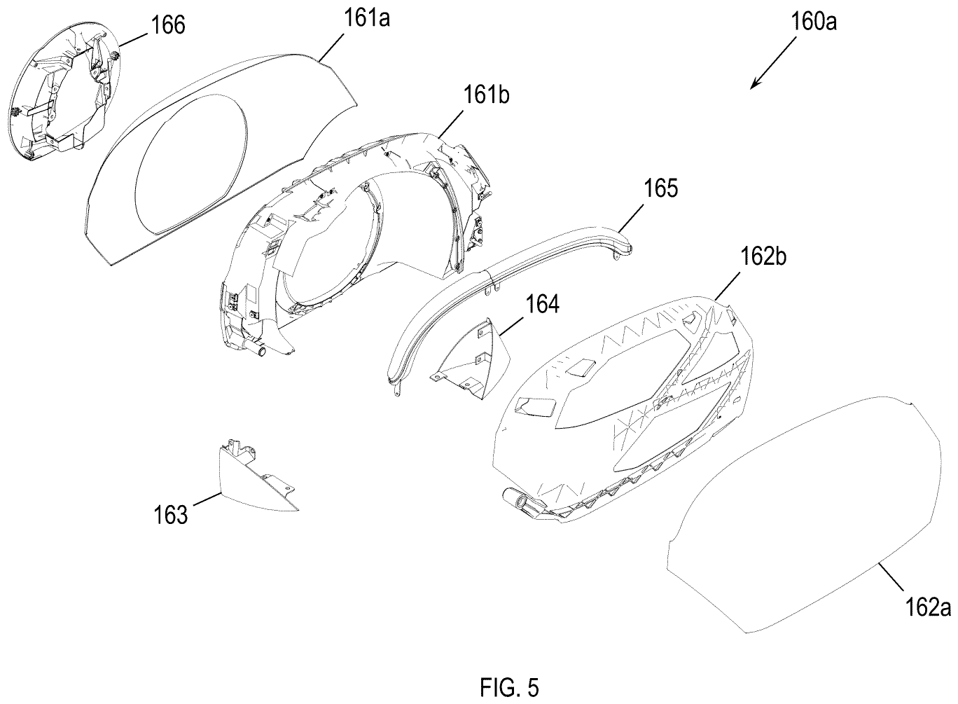

Additional components of the wheel housing assembly 160a are shown in the exploded view of FIG. 5. At the innermost level, the wheel housing assembly 160a comprises inner 161b and outer 162b frames rotatably coupled to each other. A light bar 165 is disposed between, and coupled to, both inner 161b and outer 162b frames. Front 163 and rear 164 bumpers are joined to the frames 161b, 162b at their forward and trailing extents. Inner 161a and outer 162a shells are joined to the inner 161b and outer 162b frames, respectively. Finally, a housing adapter 166 is coupled to the inner frame 161b.

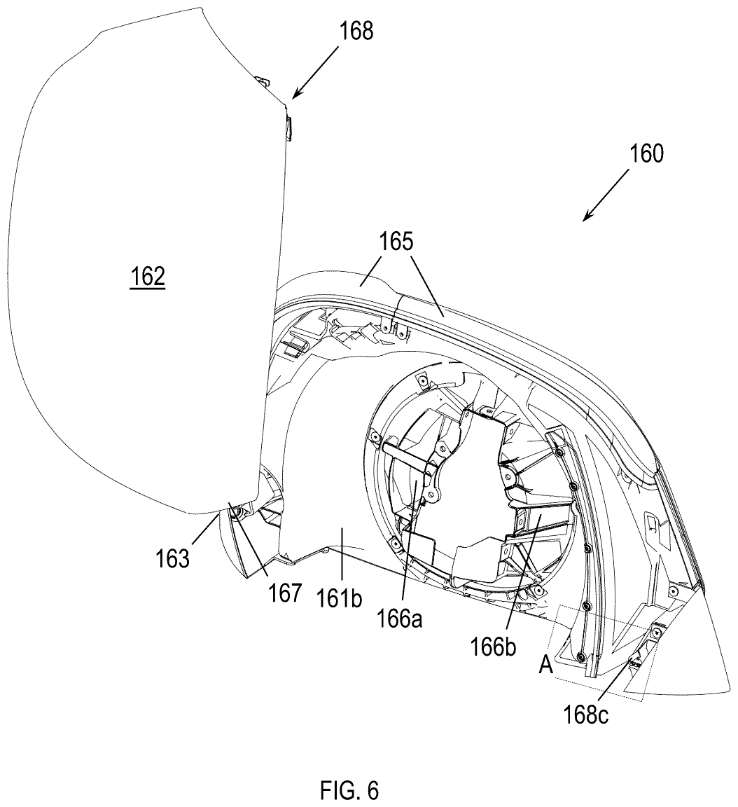

Referring to FIG. 6, the outer housing 162 is rotatably coupled to the inner housing 161 by an axle 167 disposed behind the front bumper 163 allowing it to swing open toward the front of the housing 160, coming to rest in a substantially vertical orientation relative to its closed position. With the outer housing 162 in this position, the tire may be serviced, such as by adjusting the air pressure or changing a flat. Further repair and maintenance, such as servicing of the brakes and/or in-wheel motor are also possible. Alternatively, the outer half of the housing 162 may open toward the rear of the housing 160 about an axis in front of the rear bumper (not shown). In another embodiment, the outer housing 162 may swing open sideways about an axis near the top of the housing 160 (not shown). The opening action of the outer housing 162 may be assisted by a torsion spring, a counterweight or other mechanical actuation including a pneumatic piston, an electro-mechanical actuator, and the like. In the open position the outer housing 162 may be partially or completely latched such that it requires release by a rotational force substantially greater than gravity or release of a latch, respectively. In the closed position the outer housing 162 may be held in place by a latch 168, by an interference fit, by gravity or by some combination thereof. In this way the outer housing 162 may provide access to the wheel and tire assembly without disassembly of the wheel housing 160.

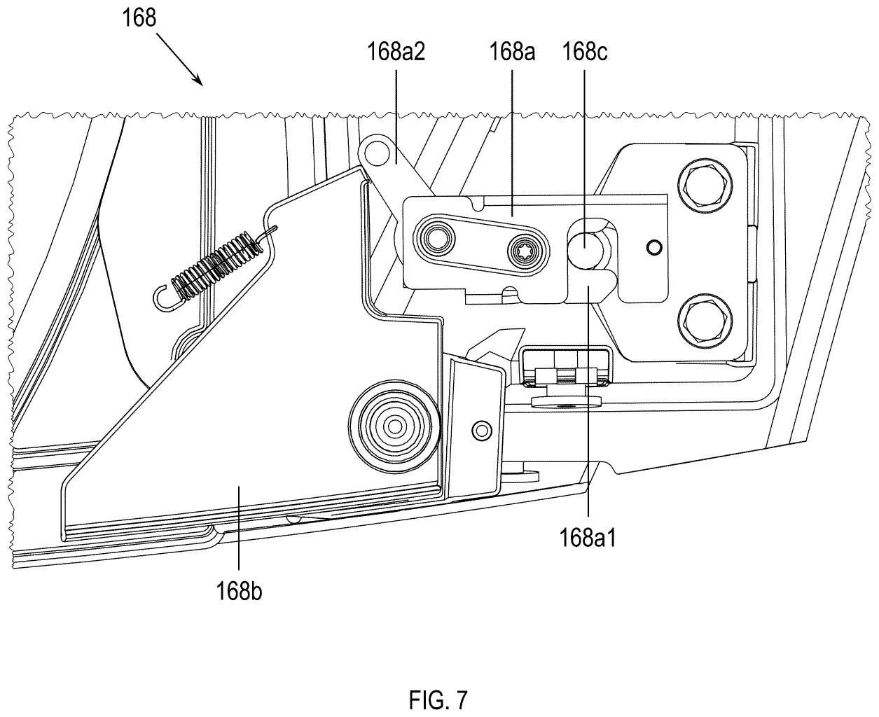

In the embodiment of FIG. 6 the latch 168 is attached to the trailing edge of the outer housing 162. The latch 168 couples to a pin 168c disposed in the inner housing frame 161b. FIG. 7 gives an expanded view of detail A of FIG. 6 in which the latch assembly 168 is in a closed position and the outer shell 162a and frame 162b have been removed for visibility. The latch assembly 168 comprises a latching mechanism 168a including a pin clasp 168a1 and actuating lever 168a2. In the closed position the clasp 168a1 is rotatably coupled to the pin 168c but prevented from rotating by the lever 168a2. The actuating lever 168a2 may be moved by a release handle 168b thereby rotating the clasp 168a1 such that it may be freed from the pin 168c. The handle 168b is restored to the closed position by a spring attached to the outer frame 162b (not shown). The latching mechanism of FIGS. 6 and 7 are by way of illustration and should not be construed as limiting.

The wheel housing 160 further comprises an adapter 166 with front and rear portions which cover the gap between the suspension/steering bracket 711 and the inner half of the housing 161. The front portion of the adapter 166 comprises an air intake 166a for cooling of the in-wheel motors (not shown). The rear portion of the adapter comprises an air exhaust 166b. The suspension/steering bracket 711 comprises a knuckle 712 for the wheel axle, suspension pivot points 713a, 713b and a steering pivot point 714. The adapter 166 may be coupled to both the bracket 711 and the inner half of the housing 161 (not shown) at a plurality of attach points 166c. In this way, the housing 160 both steers with the steerable wheel and floats with the wheel suspension.

While certain configurations of structures have been illustrated for the purposes of presenting the basic structures of the present invention, one of ordinary skill in the art will appreciate that other variations are possible which would still fall within the scope of the appended claims. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wheel housing for the external wheel of a vehicle comprising:
inner and outer halves, each half comprising;
a frame and a shell; and
an adapter disposed on the inner half;
wherein the outer half is rotatably coupled to the inner half such that the outer half may be moved from a closed position to an open position clear of the wheel without disassembly of the wheel housing.

2. The housing of claim 1 in which the axis of rotation is disposed near the front, rear or top of the housing.

3. The housing of claim 1 wherein the adapter is coupled to a steering/suspension bracket.

4. The housing of claim 1 further comprising a light bar disposed between the inner and outer halves.

5. The housing of claim 1 further comprising front and rear bumpers disposed on the inner and outer halves.

6. The housing of claim 1 wherein the frame and shell may be conjoined, such as by co-molding, adhesive or fastener joining methods.

7. The housing of claim 1 wherein the outer half is latched in the closed and/or open position.

8. The housing of claim 7 wherein the latch is formed by mechanical coupling, mechanical interference, gravity or a combination thereof.

9. The housing of claim 1 wherein actuation of the outer half from a closed position to an open position is assisted by one of a group consisting of: a torsion spring, a counterweight, an electro-mechanical actuator and a pneumatic actuator.
